(19) United States
(12) Patent Application Publication
(10) Pub. No.: US 2014/0270785 A1
(43) Pub. Date: Sep. 18, 2014

(54) ELECTRO-PHOTONIC MEMORY SYSTEM

(71) Applicant: Samsung Electronics Co., Ltd., Suwon-Si (KR)

(72) Inventors: Jeong-kyoum KIM, Seoul (KR); Jung-hwan CHOI, Hwaseong-si (KR); In-dal SONG, Seoul (KR)

(73) Assignee: Samsung Electronics Co., Ltd., Suwon-Si (KR)

(21) Appl. No.: 14/193,728

(22) Filed: Feb. 28, 2014

(30) Foreign Application Priority Data
Mar. 14, 2013 (KR) 10-2013-0027495

(51) Int. Cl. H04B 10/2575

(52) U.S. Cl. CPC H04B 10/2575
USPC 398/115

(57) ABSTRACT

An electro-photonic memory system includes a semiconductor memory device for storing data by receiving a first electrical signal, a memory controller for generating a second electrical signal to control the semiconductor memory device, an electrical-to-optical converter for receiving the second electrical signal from the memory controller and converting the second electrical signal into an optical signal, the electrical-to-optical converter separate from the memory controller, and an optical-to-electrical converter for receiving the optical signal from the electrical-to-optical converter and converting the optical signal into the first electrical signal.

### CROSS-REFERENCE TO RELATED APPLICATIONS

This application claims the benefit of Korean Patent Application No. 10-2013-0027495, filed on Mar. 14, 2013, in the Korean Intellectual Property Office, the disclosure of which is incorporated herein in its entirety by reference.

### BACKGROUND

1. Field

Example embodiments of the inventive concepts relate to an electro-photonic memory system, and more particularly, to an electro-photonic memory system using an electrical signal and an optical signal.

2. Description of the Related Art

A method of transmitting a data signal in the form of an optical signal has been performed in response to a request for high-speed data transmission. When an optical communication is employed, interference between optical signals having a plurality of wavelengths is relatively low and the optical signals may thus be simultaneously transmitted. The optical communication uses an optical transmission device that transmits information via an optical fiber cable and is mainly used in a relatively wide area network. Also, as operating speeds and data capacities of electronic devices have rapidly increased, an optical communication system has been employed even in a local area network, e.g., board-to-board connections and chip-to-chip connections.

Recently, research has been conducted into an interconnection method using an optical signal to overcome limits to signal transmission speeds, signal processing capacities, and signal integrity caused when the existing computing/memory system that uses an electrical signal employs a multi-drop method.

### SUMMARY

Example embodiments of the inventive concepts provide an electro-photonic memory system in which an optical interconnector is included between electrical integrated circuits (ICs).

According to example embodiments of the inventive concepts, an electro-photonic memory system includes a semiconductor memory device for storing data by receiving a first electrical signal, a memory controller for generating a second electrical signal to control the semiconductor memory device, an electrical-to-optical converter for receiving the second electrical signal from the memory controller and converting the second electrical signal into an optical signal, the electrical-to-optical converter separate from the memory controller, and an optical-to-electrical converter for receiving the optical signal from the electrical-to-optical converter and converting the optical signal into the first electrical signal.

The optical-to-electrical converter may be separate from the semiconductor memory device. The semiconductor memory device may be a plurality of the semiconductor memory devices. The optical-to electrical converter may be a plurality of optical-to-electrical converters, and the plurality of the semiconductor memory devices may be connected to the plurality of optical-to-electrical converters, respectively.

An optical interconnector may be connected between the electrical-to-optical converter and each of the plurality of optical-to-electrical converters. The optical signal may be a plurality of optical signals, and an electrical-to-optical connector module may include the electrical-to-optical converter and an optical splitter. The plurality of optical signals generated by the electrical-to-optical converter may be supplied by the optical splitter to the plurality of optical-to-electrical converters, respectively.

The optical-to-electrical converter may be embedded in an optical cable. The electrical-to-optical converter may be connected to the optical-to-electrical converter via an optical interconnector embedded in an optical cable. The electrical-to-optical converter may be connected to the optical-to-electrical converter via an optical interconnector embedded in a mother board.

According to example embodiments, an electro-photonic memory system includes a semiconductor memory device for storing data by receiving a first electrical signal, a memory controller for generating a second electrical signal to control the semiconductor memory device, an electrical-to-optical converter for receiving the second electrical signal from the memory controller and converting the second electrical signal into an optical signal, and an optical-to-electrical converter for receiving the optical signal from the electrical-to-optical converter and converting the optical signal into the first electrical signal, the optical-to-electrical converter being separate from the semiconductor memory device.

The semiconductor device may be a plurality of semiconductor memory devices, the optical-to electrical converter may be a plurality of optical-to-electrical converters, and the plurality of semiconductor memory devices may be connected to the plurality of optical-to-electrical converters, respectively. The optical-to-electrical converter may be embedded in an optical cable. The electrical-to-optical converter may be connected to the optical-to-electrical converter via an optical interconnector embedded in an optical cable. The electrical-to-optical converter may be connected to the optical-to-electrical converter via an optical interconnector embedded in a mother board.

According to example embodiments, an electro-photonic memory system includes an optical interconnector connected between an electrical-to-optical converter and at least one optical-to-electrical converter.

The optical-to-electrical converter may be embedded in an optical cable. The electrical-to-optical converter may be connected to the optical-to-electrical converter via an optical interconnector embedded in an optical cable. The electrical-to-optical converter may be connected to the optical-to-electrical converter via an optical interconnector embedded in a mother board.

The system may further include a semiconductor memory device separate from the at least one optical-to-electrical converter, and a memory controller separate from the electrical-to-optical converter.

### BRIEF DESCRIPTION OF THE DRAWINGS

Example embodiments of the inventive concepts will be more clearly understood from the following detailed description taken in conjunction with the accompanying drawings in which:

FIG. 1 illustrates an electro-photonic memory system according to example embodiments of the inventive concepts;

FIG. 2 illustrates an electro-photonic memory system according to example embodiments of the inventive concepts;

FIG. 3 illustrates an electro-photonic memory system according to example embodiments of the inventive concepts;

FIG. 4 illustrates an electro-photonic memory system according to example embodiments of the inventive concepts;

FIG. 5 illustrates an electro-photonic memory system according to example embodiments of the inventive concepts;

FIG. 6 illustrates an electro-photonic memory system according to example embodiments of the inventive concepts;

FIG. 7 illustrates an electro-photonic memory system according to example embodiments of the inventive concepts;

FIGS. 8A-8F illustrate optical dividers according to various embodiments of the inventive concept;

FIG. 9 illustrates an electro-photonic memory system according to example embodiments of the inventive concepts;

FIG. 10 illustrates an optical filter array according to example embodiments of the inventive concepts;

FIG. 11 illustrates an electro-photonic memory system according to example embodiments of the inventive concepts;

FIG. 12 illustrates a first converter according to example embodiments of the inventive concepts;

FIG. 13 illustrates an electro-photonic memory system according to example embodiments of the inventive concepts;

FIG. 14 is a block diagram of an application example of an electro-photonic memory system according to example embodiments of the inventive concepts;

FIG. 15 is a block diagram of an application example of an electronic product including an electro-photonic memory system, according to example embodiments of the inventive concepts;

FIG. 16 is a functional block diagram of an electro-photonic memory system according to example embodiments of the inventive concepts; and

FIG. 17 illustrates an electro-photonic memory system according to example embodiments of the inventive concepts.

### DETAILED DESCRIPTION

Hereinafter, example embodiments of the inventive concepts will be described in greater detail with reference to the accompanying drawings. The embodiments set forth herein are provided so that this disclosure will be thorough and complete and will fully convey the concepts of the inventive concepts to those of ordinary skill in the art. The inventive concepts may be embodied in different forms and particular embodiments of the inventive concepts will thus be illustrated in the drawings and described in the present disclosure in detail. However, the inventive concepts are not limited to the particular embodiments and should be construed as covering all of modifications, equivalents, and substitutes thereof. The same reference numerals represent the same elements throughout the drawings. In the drawings, the lengths and sizes of layers and regions may be exaggerated for clarity.

The terminology used herein is for the purpose of describing particular embodiments only and is not intended to be limiting of the inventive concepts. As used herein, the singular forms “a”, “an”, and “the” are intended to include the plural forms as well, unless the context clearly indicates otherwise. It will be further understood that the terms “comprise” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items.

FIG. 1 illustrates an electro-photonic memory system 100 according to example embodiments of the inventive concepts.

Referring to FIG. 1, the electro-photonic memory system 100 includes a memory controller 110, an electrical-to-optical (EO) converter 120, an optical-to-electrical (OE) converter 130, and a semiconductor memory device 140. The electro-photonic memory system 100 may further include an electrical interconnector 150, an optical interconnector 160, an electrical interconnector 151, and a mother board 170.

The memory controller 110 may generate an electrical signal to control the semiconductor memory device 140. The memory controller 110 may be, for example, a central processing unit (CPU) of a computer or a main controller of a personal mobile terminal. Otherwise, the memory controller 110 may be any of various controllers capable of controlling random access memory (RAM). However, the inventive concepts are not limited thereto, and the memory controller 110 may be a controller capable of controlling a large-capacity storage unit.

The electrical signal generated by the memory controller 110 may be a command signal, a clock signal, an address signal and/or a write data signal.

The EO converter 120 may receive an electrical signal from the memory controller 110 and convert the electrical signal into an optical signal. The EO converter 120 may include an optical transmitter 121 and a wavelength division multiplexer 123.

The optical transmitter 121 may receive an optical signal from a light source (not shown), and modulate the wavelength of the optical signal according to a transmission data signal. The light source and the optical transmitter 121 may output optical signals having different wavelengths.

The wavelength division multiplexer 123 may allow an optical signal transmitted from the optical transmitter 121 to pass therethrough. The wavelength division multiplexer 123 may use an arrayed waveguide grating. The wavelength division multiplexer 123 may distribute optical signals incident thereon to arrayed waveguides of an arrayed waveguide system. The arrayed waveguide system may have a waveguide structure formed of quartz-based glass on a substrate formed of silicon. The optical signals passing through the wavelength division multiplexer 123 may be transmitted to the optical interconnector 160.

The optical interconnector 160 may connect the EO converter 120 and the OE converter 130 to each other. The optical interconnector 160 may transmit an optical signal transmitted from the EO converter 120 to the OE converter 130 using a mirror 165. The optical interconnector 160 may be included in the mother board 170.

The optical interconnector 160 may transmit an optical signal by using an integrated planar waveguide, an optical waveguide, or an optical fiber. Optical signals using wavelength division multiplexing are enabled to effectively use a relatively wide bandwidth provided by optical fiber.

The OE converter 130 may receive an optical signal from the EO converter 120 and convert the optical signal into an electrical signal. The OE converter 130 may include an optical receiver 131 and a wavelength division demultiplexer 133.

The wavelength division demultiplexer 133 may receive an optical signal transmitted via the optical interconnector 160 and divide a bandwidth of the optical signal in units of wavelengths. The optical signal passing through the wavelength division demultiplexer 133 may be transmitted to the optical receiver 131.

The optical receiver 131 may receive an optical signal via the wavelength division demultiplexer 133. The optical receiver 131 may convert the optical signal whose wavelength is divided into the electrical signal that is the original transmission data signal.

The semiconductor memory device 140 receives an optical signal from the OE converter 130. The semiconductor memory device 140 may be connected to the OE converter 130 via the electrical interconnector 151. The semiconductor memory device 140 may include dynamic RAM (DRAM), static RAM (SRAM), phase-change RAM (PRAM), magnetic RAM (MRAM), resistive RAM (ReRAM), ferroelectric RAM (FRAM), a NOR flash memory, a NAND flash memory, and/or a fusion flash memory (e.g., a memory that is a combination of an SRAM buffer, a NAND flash memory, and a NOR interface logic).

An operation of the electro-photonic memory system 100 will now be described.

The memory controller 110 may generate an electrical signal to control the semiconductor memory device 140. The EO converter 120 may receive the electrical signal from the memory controller 110 and convert the electrical signal into an optical signal. The OE converter 130 may receive an optical signal from the EO converter 120 and convert the optical signal into an electrical signal. The semiconductor memory device 140 receives the electrical signal from the OE converter 130. The semiconductor memory device 140 may perform a write/read operation according to a request from the memory controller 110.

According to example embodiments of the inventive concepts, the EO converter 120 is packaged separately from the memory controller 110. In other words, the EO converter 120 is installed separate from the memory controller 110. Because the EO converter 120 is separated from the memory controller 110, a memory system in which an optical interconnection is formed using the existing controller using only an electrical signal may be manufactured. In the present disclosure, the term ‘package’ may be understood as a packing to form an independent chip such that it is enclosed with an encapsulant to be individually separated from other chips.

According to example embodiments of the inventive concepts, the OE converter 130 is packaged separately from the semiconductor memory device 140. That is, the OE converter 130 is installed separate from the semiconductor memory device 140. Because the OE converter 130 is separated from the semiconductor memory device 140, a memory system in which an optical interconnection is formed using the existing memory using only an electrical signal may be manufactured.

Because the electro-photonic memory system 100 according to example embodiments of the inventive concepts may use the existing controller and memory, manufacturing costs may be saved. Also, because data is transmitted using an optical signal, limitations to signal processing speeds and capacities, caused when data is transmitted using an electrical signal, may be overcome.

FIG. 2 illustrates an electro-photonic memory system 100_{—}a according to example embodiments of the inventive concepts.

Referring to FIG. 2, the electro-photonic memory system 100_{—}a includes a memory controller 110_{—}a, an EO converter 120_{—}a, a plurality of OE converters 130A and 130B, and a plurality of semiconductor memory devices 140A and 140B. The electro-photonic memory system 100_{—}a may further include an electrical interconnector 150_{—}a, an optical interconnector 160_{—}a, electrical interconnectors 151A and 151B, and a mother board 170_{—}a. The electro-photonic memory system 100_{—}a is substantially the same as the electro-photonic memory system 100 of FIG. 1 except that the plurality of semiconductor memory devices 140A and 140B are included.

The memory controller 110_{—}a may generate an electrical signal to control the semiconductor memory devices 140A and 140B. The EO converter 120_{—}a may receive an electrical signal from the memory controller 110_{—}a and convert the electrical signal into an optical signal. Although not shown, the EO converter 120_{—}a may include an optical transmitter and a wavelength division multiplexer.

The optical interconnector 160_{—}a may connect the OE converter 130A and the EO converter 120_{—}a. The optical interconnector 160_{—}a may be embedded in the mother board 170_{—}a.

The optical interconnector 160_{—}a may transmit an optical signal using an integrated planar waveguide, an optical waveguide, or an optical fiber. The optical interconnector 160_{—}a may include mirrors 165A and 165B to supply an optical signal to the OE converters 130A and 130B.

The OE converters 130A and 130B may receive an optical signal from the EO converter 120_{—}a, and convert the optical signal into an electrical signal. Although not shown, the OE converters 130A and 130B may each include an optical receiver and a wavelength division demultiplexer.

The semiconductor memory device 140A receives an electrical signal from the OE converter 130A. The semiconductor memory device 140A may be connected to the OE converter 130A via the electrical interconnector 151A. The semiconductor memory device 140B receives an electrical signal from the OE converter 130B. The semiconductor memory device 140B may be connected to the OE converter 130B via the electrical interconnector 151B. Although in the present embodiment, the number of semiconductor memory devices is two, the number of semiconductor memory devices may be more than two according to various other embodiments.

According to example embodiments of the inventive concepts, the EO converter 120_{—}a is packaged separately from the memory controller 110_{—}a. That is, the EO converter 120_{—}a is installed separate from the memory controller 110_{—}a. Thus, because the EO converter 120_{—}a is separated from the memory controller 110_{—}a, a memory system in which an optical interconnection is formed using the existing controller using only an electrical signal may be manufactured.

According to example embodiments of the inventive concepts, the OE converter 130A is packaged separately from the semiconductor memory device 140A. That is, the OE converter 130A is installed separate from the semiconductor memory device 140A. Also, the OE converter 130A is packaged separately from the semiconductor memory device 140B. That is, OE converter 130B is installed separate from the semiconductor memory device 140B. Thus, because the OE converters 130A and 130B according to example embodiments of the inventive concepts are separated from the semiconductor memory devices 120A and 140B, a memory system in which an optical interconnection is formed using the existing memory using only an electrical signal may be manufactured.

FIG. 3 illustrates an electro-photonic memory system 200 according to example embodiments of the inventive concepts.

Referring to FIG. 3, the electro-photonic memory system 200 includes a memory controller 210, an EO converter 220, an OE converter 230, and a semiconductor memory device 240. The electro-photonic memory system 200 may further include an electrical interconnector 250, an optical interconnector 260, an electrical interconnector 251, and an optical cable 270.

The memory controller 210 may generate an electrical signal to control the semiconductor memory device 240. The memory controller 210 may be, for example, a CPU of a computer or a main controller of a personal mobile terminal. Otherwise, the memory controller 210 may be a controller capable of controlling RAM. However, the inventive concepts are not limited thereto, and the memory controller 210 may be a controller capable of controlling a large-capacity storage unit.

An electrical signal generated by the memory controller 210 may include a command signal, a clock signal, an address signal, and/or a write data signal.

The EO converter 220 may receive an electrical signal from the memory controller 210 and convert the electrical signal into an optical signal. Although not shown, the EO converter 220 may include an optical transmitter and a wavelength division multiplexer. The optical signal generated by the EO converter 220 may be transmitted to the semiconductor memory device 240 via the optical cable 270.

The optical cable 270 may include the optical interconnector 260, an OE converter 230, and the electrical interconnector 251.

The optical interconnector 260 may connect the EO converter 220 and the OE converter 230 to each other. The OE converter 230 may receive an optical signal from the EO converter 220 and convert the optical signal into an electrical signal. Although not shown, the OE converter 230 may include an optical receiver and a wavelength division demultiplexer.

The semiconductor memory device 240 receives an electrical signal from the OE converter 230. The semiconductor memory device 240 may be connected to the OE converter 230 via the electrical interconnector 251. The semiconductor memory device 240 may include DRAM, SRAM, PRAM, MRAM, ReRAM, FRAM, a NOR flash memory, a NAND flash memory, and/or a fusion flash memory (e.g., a memory that is combination of an SRAM buffer, a NAND flash memory, and a NOR interface logic). Otherwise, the semiconductor memory device 240 may be a large-capacity storage device including these memories. For example, the semiconductor memory device 240 may be a solid state drive (SSD).

According to example embodiments of the inventive concepts, the EO converter 220 is installed separate from the memory controller 210. Because the EO converter 220 is separated from the memory controller 210, a memory system in which an optical interconnection is formed using the existing controller using only an electrical signal may be manufactured.

According to example embodiments of the inventive concepts, the OE converter 230 is installed separate from the semiconductor memory device 240. Because the OE converter 230 is separated from the semiconductor memory device 240, a memory system in which an optical interconnection using the existing memory using only an electrical signal may be manufactured.

FIG. 4 illustrates an electro-photonic memory system 200_{—}a according to example embodiments of the inventive concepts.

Referring to FIG. 4, the electro-photonic memory system 200_{—}a includes a memory controller 210_{—}a, an EO converter 220_{—}a, a splitter 280_{—}a, OE converters 230A, 230B, and 230C, and semiconductor memory devices 240A, 240B, and 240C. The electro-photonic memory system 200_{—}a may further include an electrical interconnector 250_{—}a, optical interconnectors 260A, 260B, and 260C, electrical interconnectors 251A, 251B, and 251C, and optical cables 270A, 270B, and 270C. The EU converter 220_{—}a and the splitter 280_{—}a may be included in an EO connector module 290_{—}a.

The memory controller 210_{—}a may generate an electrical signal to control the semiconductor memory devices 240A, 240B, and 240C. The EO converter 220_{—}a may receive an electrical signal from the memory controller 210_{—}a and convert the electrical signal into an optical signal. Although not shown, the EO converter 220_{—}a may include an optical transmitter and a wavelength division multiplexer.

The optical cable 270A may include the optical interconnector 260A, the OE converter 230A, and the electrical interconnector 251A. The optical cable 270B may include the optical interconnector 260B, the OE converter 230B, and the electrical interconnector 251B. The optical cable 270C may include the optical interconnector 260C, the OE converter 230C, and the electrical interconnector 251C.

The optical interconnectors 260A, 260B, and 260C may connect the OE converters 230A, 230B, and 230C to the splitter 280_{—}a, respectively. The OE converters 230A, 230B, and 230C may receive an optical signal from the splitter 280_{—}a, and convert the optical signal into an electrical signal. Although not shown, the OE converters 230A, 230B, and 230C may each include an optical receiver and a wavelength division demultiplexer.

The semiconductor memory devices 240A, 240B, and 240C receive an electrical signal from the OE converters 230A, 230B, and 230C, respectively. The semiconductor memory devices 240A, 240B, and 240C may be connected to the OE converters 230A, 230B, and 230C via the electrical interconnectors 251A, 251B, and 251C, respectively.

According to example embodiments of the inventive concepts, the EO converter 220_{—}a is installed separate from the memory controller 210_{—}a. Because the EO converter 220_{—}a is separated from the memory controller 210_{—}a, a memory system in which an optical interconnection is formed using the existing controller using only an electrical signal may be manufactured.

According to example embodiments of the inventive concepts, the OE converters 230A, 230B, and 230C are installed separate from the semiconductor memory devices 240A, 240B, and 240C, respectively. Because the OE converters 230A, 230B, and 230C are separate from the semiconductor memory devices 240A, 240B, and 240C, a memory system in which an optical interconnection is formed using the existing memory using only an electrical signal may be manufactured.

FIG. 5 illustrates an electro-photonic memory system 300 according to example embodiments of the inventive concepts.

Referring to FIG. 5, the electro-photonic memory system 300 includes a memory controller 310, a first converter 320, a plurality of second converters 330A and 330B, and a plurality of semiconductor memory devices 340A and 340B. The electro-photonic memory system 300 may further include an electrical interconnector 350, an optical interconnector 360, electrical interconnectors 351A and 351B, and a mother board 370. The electro-photonic memory system 300 operates similar to the electro-photonic memory system 100_{—}a of FIG. 2. However, the first converter 320 and the plurality of second converters 330A and 330B may not only transmit an electrical/optical signal from the memory controller 310 to the semiconductor memory devices 340A and 340B but also transmit an electrical/optical signal from the semiconductor memory devices 340A and 340B to the memory controller 310. That is, the first converter 320 and the plurality of second converters 330A and 330B perform bi-directional signal conversion. Thus, the first converter 320 may include an EO converter 321 and an OE converter 325, and the plurality of second converters 330A and 330B may each include an EO converter 331A or 331B and an OE converter 335A or 335B.

The memory controller 310 may generate an electrical signal to control the semiconductor memory devices 340A and 340B.

The first converter 320 may receive an electrical signal from the memory controller 310 via the electrical interconnector 350, and convert the electrical signal into an optical signal. Also, the first converter 320 may receive an optical signal from the second converter 330A, and convert the optical signal into an electrical signal.

The optical interconnector 360 may connect the first converter 320 and the second converter 330A to each other. The optical interconnector 360 may be embedded in the mother board 370. The optical interconnector 360 may include mirrors 365A and 365B to supply an optical signal to the plurality of second converters 330A and 330B, respectively.

The plurality of second converters 330A and 330B may receive an optical signal from the first converter 320 via the optical interconnector 360, and convert the optical signal into an electrical signal. The plurality of second converters 330A and 330B may receive an electrical signal from the semiconductor memory devices 340A and 340B via the electrical interconnectors 351A and 351B, respectively, and convert the electrical signal into an optical signal.

The semiconductor memory device 340A receives an electrical signal from the second converter 330A. The semiconductor memory device 340A may be connected to the second converter 330A via the electrical interconnector 351A. The semiconductor memory device 340B receives an electrical signal from the second converter 330B. The semiconductor memory device 340B may be connected to the second converter 330B via the electrical interconnector 351B.

An operation of the electro-photonic memory system 300 will now be described.

The memory controller 310 may generate an electrical signal to control the semiconductor memory device 340A. The first converter 320 may receive an electrical signal from the memory controller 310, and convert the electrical signal into an optical signal. The second converter 330A may receive an optical signal from the first converter 320, and convert the optical signal into an electrical signal. The semiconductor memory device 340A receives an electrical signal from the second converter 330A. The semiconductor memory device 340A may perform a write/read operation in response to a request from the memory controller 310.

For example, when the semiconductor memory device 340A receives a read command, the second converter 330A may receive read data in the form of an electrical signal. The second converter 330A may receive an electrical signal and convert the electrical signal into an optical signal. The first converter 320 may receive an optical signal and convert the optical signal into an electrical signal. The memory controller 310 may receive read data from the semiconductor memory device 340A. This operation is also performed similarly when the memory controller 310 generates a signal with respect to the semiconductor memory device 340B.

According to example embodiments of the inventive concepts, the first converter 320 is packaged separately from the memory controller 310. That is, the first converter 320 is installed separate from the memory controller 310. Because the first converter 320 is separated from the memory controller 310, a memory system in which an optical interconnection is formed using the existing controller using only an electrical signal may be manufactured.

According to example embodiments of the inventive concepts, the second converter 330A is packaged separately from the semiconductor memory device 340A. That is, the second converter 330A is installed separate from the semiconductor memory device 340A. Also, the second converter 330B is packaged separately from the semiconductor memory device 340B. That is, the second converter 330B is separated from the semiconductor memory device 340B. Thus, because an OE converter according to example embodiments of the inventive concepts is separated from a memory, a memory system in which an optical interconnection is formed using the existing memory using only an electrical signal may be manufactured.

FIG. 6 illustrates an electro-photonic memory system 400 according to example embodiments of the inventive concepts.

Referring to FIG. 6, the electro-photonic memory system 400 includes a memory controller 410, an EO converter 420, an optical divider 480, OE converters 430A and 430B, and semiconductor memory devices 440A and 440B. The electro-photonic memory system 400 may further include optical interconnectors 460A and 460B, electrical interconnectors 451A and 451B, and optical cables 470A and 470B. The optical divider 480 may include an optical waveguide 481 and a socket 483.

The memory controller 410 may generate an electrical signal to control the semiconductor memory devices 440A and 440B. The EO converter 420 may receive an electrical signal from the memory controller 410 and convert the electrical signal into an optical signal. The EO converter 420 may be connected to the optical divider 480.

The optical cable 470A may include the optical interconnector 460A, the OE converter 430A, and the electrical interconnector 451A. The optical cable 470B may include an optical interconnector 460B, the OE converter 430B, and the electrical interconnector 451B.

The optical interconnectors 460A and 460B may connect the OE converters 430A and 430B to the optical divider 480, respectively. The OE converters 430A and 430B may receive an optical signal from the optical divider 480 and convert the optical signal into an electrical signal.

The semiconductor memory devices 440A and 440B receive an electrical signal from the OE converters 430A and 430B, respectively. The semiconductor memory devices 440A and 440B may be connected to the OE converters 430A and 430B via the electrical interconnectors 451A and 451B, respectively.

The optical divider 480 may include the optical waveguide 481 and the socket 483. The socket 483 receives an external optical signal. The received optical signal is transmitted via the optical waveguide 481. For example, the optical signal received from the socket 483 may be divided into two signals via the optical waveguide 481, and the two signals may be transmitted to the semiconductor memory devices 440A and 440B, respectively. According to example embodiments of the inventive concepts, the optical divider 480 may be replaced with one of optical dividers 480A to 480F illustrated in FIGS. 8A-8F.

According to example embodiments of the inventive concepts, because the electro-photonic memory system 400 includes the optical divider 480, only one optical cable is connected to the EO converter 420. Thus, an EO converter having the same specification may be used as the EO converter 420 regardless of the number of memory devices.

According to example embodiments of the inventive concepts, because the electro-photonic memory system 400 includes the optical divider 480, an optical signal generated by the EO converter 420 may be divided into equal-sized sub signals, and the sub signals may be transmitted to the semiconductor memory devices 440A and 440B, respectively.

According to example embodiments of the inventive concepts, the OE converters 430A and 430B are installed separate from the semiconductor memory devices 440A and 440B, respectively. Because the OE converters 430A and 430B are respectively separated from the semiconductor memory devices 440A and 440B, a memory system in which an optical interconnection is formed using the existing memory using only an electrical signal may be manufactured.

FIG. 7 illustrates an electro-photonic memory system 400_{—}a according to example embodiments of the inventive concepts.

Referring to FIG. 7, the electro-photonic memory system 400_{—}a includes a memory controller 410_{—}a, an EO converter 420_{—}a, optical dividers 480_{—}a1, 480_{—}a2, and 480_{—}a3, OE converters 430A, 430B, 430C, and 430D, and semiconductor memory devices 440A, 440B, 440C, and 440D. The optical dividers 480_{—}a1, 480_{—}a2, and 480_{—}a3 may be each replaced with one of the optical dividers 480A to 480F illustrated in FIGS. 8A-8F. An operation of the electro-photonic memory system 400_{—}a is substantially the same as that of the electro-photonic memory system 400. Thus, the electro-photonic memory system 400_{—}a will now be described focusing on its difference from the electro-photonic memory system 400.

According to example embodiments of the inventive concepts, the electro-photonic memory system 400_{—}a includes the optical dividers 480_{—}a1, 480_{—}a2, and 480_{—}a3, and only one optical cable is thus connected to the EO converter 420_{—}a. Thus, an EO converter having the same specification may be used as the EO converter 420_{—}a regardless of the number of memory devices.

Also, because the electro-photonic memory system 400_{—}a further includes the optical dividers 480_{—}a1, 480_{—}a2, and 480_{—}a3, an optical signal generated by the EO converter 420_{—}a may be divided into equal-sized sub signals, and the sub signals may be transmitted to the semiconductor memory devices 440A, 440B, 440C, and 440D, respectively.

FIGS. 8A-8F illustrates the optical dividers 480A to 480F according to various embodiments of the inventive concepts.

Referring to FIGS. 8A-8C, in the optical dividers 480A to 480C, the sum of the intensity of an input optical signal and the intensity of an output optical signal is the same. The optical divider 480A may include an optical waveguide 481A and a socket 483A. The optical divider 480B may include an optical waveguide 481B and a socket 483B. The optical divider 480C may include an optical waveguide 481C and a socket 483C.

Referring to FIGS. 8D-8F, in the optical dividers 480D to 480F, the sum of the intensity of an input optical signal and the intensity of an output optical signal is different. The optical divider 480D may include an optical waveguide 481D, a socket 483D, and an amplifier 485D. The optical divider 480E may include an optical waveguide 481E, a socket 483E, and an amplifier 485E. The optical divider 480F may include an optical waveguide 481F, a socket 483F, and an amplifier 485F.

FIG. 9 illustrates an electro-photonic memory system 500 according to example embodiments of the inventive concepts.

Referring to FIG. 9, the electro-photonic memory system 500 includes a memory controller 510, a second converter 520, an optical filter array 580, first converters 530, and semiconductor memory devices 540. The electro-photonic memory system 500 may further include a memory module (electrical interconnector) 550. The memory module 550 may include the semiconductor memory devices 540, the first converters 530, and the optical filter array 580.

The memory controller 510 may generate an electrical signal to control the semiconductor memory devices 540. The second converter 520 may receive an electrical signal from the memory controller 510 and convert the electrical signal into an optical signal. The second converter 520 may be connected to the optical filter array 580.

The optical filter array 580 may receive an optical signal from the second converter 520. For example, the optical filter array 580 may receive an optical signal having a frequency f₀ (e.g., f₀=f₁+f₂+f₃+f₄). The optical filter array 580 may select frequencies corresponding to the respective semiconductor memory devices 540 and transmit the selected frequencies to the first converters 530 corresponding to the semiconductor memory devices 540, respectively.

FIG. 10 illustrates an optical filter array 580 according to example embodiments of the inventive concepts.

Referring to FIG. 10, the optical filter array 580 may include a first filter to a fourth filter, and a coupler. The coupler may be connected to the first to fourth filters. An optical signal having a frequency f₀ (e.g., f₀=f₁+f₂+f₃+f₄) that passes through the coupler may be converted into optical signals having particular frequencies (e.g., f1, f2, f3, and f4) via these filters.

Referring back to FIG. 9, the first converters 530 may receive the corresponding optical signals having the frequencies f1, f2, f3, and f4 and convert the optical signals into electrical signals. The semiconductor memory devices 540 receive the electrical signals from the first converters 530, respectively.

According to example embodiments of the inventive concepts, because the electro-photonic memory system 500 includes the optical filter array 580, only one optical cable is connected to the second converter 520. Thus, a converter having the same specification may be used regardless of the number of memory devices.

Also, because the electro-photonic memory system 500 includes the optical filter array 580, optical signals may be transmitted to the first converters 530 in the memory module 550 at high speeds, thereby increasing a signal processing speed.

FIG. 11 illustrates an electro-photonic memory system 500_{—}a according to example embodiments of the inventive concepts.

Referring to FIG. 11, the electro-photonic memory system 500_{—}a includes a memory controller 510_{—}a, a second converter 520_{—}a, a splitter 580_{—}a, first converters 530_{—}a, and semiconductor memory devices 540_{—}a. The electro-photonic memory system 500_{—}a may further include a memory module (electrical interconnector) 550_{—}a. The memory module 550_{—}a may include the semiconductor memory devices 540_{—}a, the first converters 530_{—}a, and the optical filter array 580_{—}a.

The memory controller 510_{—}a may generate an electrical signal to control the semiconductor memory devices 540_{—}a. The second converter 520_{—}a may receive the electrical signal from the memory controller 510_{—}a and convert the electrical signal into an optical signal. The second converter 520_{—}a may be connected to the splitter 580_{—}a.

The splitter 580_{—}a may receive an optical signal from the second converter 520_{—}a. For example, the splitter 580_{—}a may receive an optical signal having a frequency f₀ (e.g., f₀=f₁+f₂+f₃+f₄) from the second converter 520_{—}a. The splitter 580_{—}a may transmit the optical signal having the frequency f₀ to the first converters 530_{—}a.

The first converters 530_{—}a may receive the optical signal having the frequency f₀ (e.g., f₀=f₁+f₂+f₃+f₄) and convert the optical signal into electrical signals. The first converters 530_{—}a may filter selected optical signals corresponding to the frequencies f₁, f₂, f₃, and f₄ from the optical signal having the frequency f₀, and generate electrical signals corresponding to the selected optical signals, respectively. The semiconductor memory devices 540_{—}a receive the electrical signals corresponding to the optical signals selected by the first converters 530_{—}a, respectively. Operations of the first converters 530_{—}a will be described in detail with reference to FIG. 12 below.

According to example embodiments of the inventive concepts, because the electro-photonic memory system 500_{—}a includes the splitter 580_{—}a, only one optical cable is connected to the second converter 520_{—}a. Thus, a converter having the same specification may be used regardless of the number of memory devices.

Also, because the electro-photonic memory system 500_{—}a includes the splitter 580_{—}a, an optical signal may be transmitted to the first converters 530_{—}a included in the memory module 550_{—}a at high speeds, thereby increasing a signal processing speed.

FIG. 12 illustrates one of the first converters 530_{—}a according to example embodiments of the inventive concepts.

Referring to FIG. 12, the first converter 530_{—}a may transmit an optical signal received via an optical link to a second tunable filter 535 via a waveguide. The second tunable filter 535 may select an optical signal based on a signal received from a wavelength selection logic unit 536, and transmit the selected optical signal to a photo detector 534. The photo detector 534 may convert the selected optical signal into an electrical signal.

A modulator 533 included in the first converter 530_{—}a may receive an electrical signal and convert the electrical signal into an optical signal. The modulator 533 may receive an optical signal that is selected from a laser light source 531 by a first tunable filter 532. The first tunable filter 532 may select an optical signal based on a signal received from the wavelength selection logic unit 536, and transmit the selected optical signal to the modulator 533. The modulator 533 may convert the electrical signal into an optical signal using the selected optical signal.

FIG. 13 illustrates an electro-photonic memory system 500_{—}b according to example embodiments of the inventive concepts.

Referring to FIG. 13, the electro-photonic memory system 500_{—}b includes a memory controller 510_{—}b, a second converter 520_{—}b, a splitter 580_{—}b, first converters 530_{—}b, and DRAM devices 540_{—}b. The electro-photonic memory system 500_{—}b may further include a memory module (electrical interconnector) 550_{—}b. The memory module 550_{—}b may include the DRAM devices 540_{—}b, the first converters 530_{—}b, and the splitter 580_{—}b. The memory module 550_{—}b may include memory interface devices, e.g., memory buffers 590_{—}b and a registering clock driver 560_{—}b. The DRAM devices 540_{—}b included in the memory module 550_{—}b may be, for example, DDR3 SDRAM devices and/or DDR4 SDRAM devices.

The electro-photonic memory system 500_{—}b is a detailed embodiment of the electro-photonic memory system 500_{—}a of FIG. 11 or the electro-photonic memory system 500 of FIG. 9. Thus, the above descriptions of the electro-photonic memory systems 500_{—}a and 500 are not provided again here.

Although FIG. 13 illustrates the splitter 580_{—}b, the splitter 580_{—}b may be replaced with the optical filter array 580 as in the electro-photonic memory system 500 of FIG. 9. Also, although FIG. 13 illustrates the first converters 530_{—}b are disposed separate from the DRAM devices 540_{—}b, the first converters 530_{—}b may be designed to be disposed in the DRAM devices 540_{—}b according to example embodiments of the inventive concepts.

According to example embodiments of the inventive concepts, because the electro-photonic memory system 500_{—}b includes the splitter 580_{—}b, only one optical cable is connected to the second converter 520_{—}b. Thus, a converter having the same specification may be used regardless of the number of memory devices.

Also, because the electro-photonic memory system 500_{—}b includes the splitter 580_{—}b, an optical signal may be transmitted to the first converters 530_{—}b in the memory module 550_{—}b at high speeds, thereby increasing a signal processing speed.

FIG. 14 is a block diagram of an application example of an electro-photonic memory system 600 according to example embodiments of the inventive concepts.

Referring to FIG. 14, the electro-photonic memory system 600 may include a system controller 690 and a semiconductor memory device 680.

The semiconductor memory device 680 may include DRAM, SRAM, PRAM, MRAM, ReRAM, FRAM, a NOR flash memory, a NAND flash memory, and/or a fusion flash memory (e.g., a memory that is a combination of an SRAM buffer, a NAND flash memory, and a NOR interface logic unit). The semiconductor memory device 680 may be embodied as one chip.

The system controller 690 may include a processor 640, RAM 650, a cache buffer 620, and a memory controller 610 that are connected via an optical bus 660. The processor 640 controls the memory controller 610 to exchange data with the semiconductor memory device 680, in response to a request (command, address, or data) from a host. Data needed to operate the processor 640 may be loaded to the RAM 650. A host interface 630 receives a request from the host and transmits the request to the processor 640, or transmits data received from the semiconductor memory device 680 through the converter 670 to the host.

Each of the processor 640, the RAM 650, the cache buffer 620, the host interface 630, and the memory controller 610 may be embodied as one chip. In the electro-photonic memory system 600, each of the chips is controlled only using an electrical signal, and a signal may be transmitted between chips by using an optical signal. Each of the chips may include a corresponding OE converter and/or a corresponding EO converter that are packaged as separate chips. Also, a signal may be exchanged between chips via the optical bus 660.

FIG. 15 is a block diagram of an application example of an electronic product 700 including an electro-photonic memory system 740, according to example embodiments of the inventive concepts.

Referring to FIG. 15, the electronic product 700 may include an input device 710, an output device 720, a processor device 730, and the electro-photonic memory system 740. The processor device 730 may control the input device 710, the output device 720, and the electro-photonic memory system 740 via corresponding optical interfaces, respectively. Although not shown, the processor device 730 may include at least one microprocessor, a digital signal processor, a microcontroller, and logic devices capable of performing functions similar to these devices. The input device 710 and the output device 720 may each include at least one device via which data is input/output.

The electro-photonic memory system 740 may be the same as the electro-photonic memory system 100 of FIG. 1. The electro-photonic memory system 740 may be an electro-photonic memory system according to example embodiments of the inventive concepts.

The electro-photonic memory system 740 may include a memory controller 741, a first converter 742, a second converter 743, and a semiconductor memory device 744. Information may be exchanged between the memory controller 741 and the first converter 742 using an electrical signal. Information may be exchanged between the second converter 743 and the semiconductor memory device 744 using an electrical signal. Information may be exchanged between the first converter 742 and the second converter 743 using an optical signal.

The memory controller 741 and the first converter 742 may be packaged as separate chips. The second converter 743 and the semiconductor memory device 744 may be packaged as separate chips. Thus, the electro-photonic memory system 740 may be manufactured using a memory controller or a semiconductor memory device that uses only an electrical signal. Because an optical signal is used to exchange information between chips, limits to a signal processing speed and capacity, caused when data is transmitted using only an electrical signal may be overcome.

FIG. 16 is a functional block diagram of an electro-photonic memory system 800 according to example embodiments of the inventive concepts.

Referring to FIG. 16, the electro-photonic memory system 800 may include optical links 801A and 801B, a control unit 804, and a memory device 808. The optical links 801A and 801B connect the control unit 804 and the memory device 808 to each other.

The control unit 804 is electrically connected to a first transmitter 805 and a first receiver 806. The control unit 804 is packaged separately from the first transmitter 805 and the first receiver 806.

The control unit 804 transmits a first electrical signal SN1 to the first transmitter 805. The first electrical signal SN1 may include command signals, clock signals, address signals, and/or write data to be transmitted to the memory device 808.

The first transmitter 805 includes a first optical transmitter 805A. The first optical transmitter 805A converts the first electrical signal SN1 into a first optical transmission signal OPT1EC, and transmits the first optical transmission signal OPT1EC to the optical link 801A. The first optical transmission signal OPT1EC is transmitted via the optical link 801A according to serial communication.

The first receiver 806 includes a first optical receiver 806B. The first optical receiver 806B converts a second optical reception signal OPT2OC received from the optical link 801B into a second electrical signal SN2 and transmits the second electrical signal SN2 to the control unit 804.

The memory device 808 is electrically connected to a second receiver 807 and a second transmitter 809. The memory device 808 is packaged separately from the second receiver 807 and the second transmitter 809.

The second receiver 807 includes a second optical receiver 807A. The second optical receiver 807A converts a first optical reception signal OPT1OC received from the optical link 801A into the first electrical signal SN1 and transmits the first electrical signal SN1 to the memory device 808.

In the memory device 808, write data is written to a memory cell according to the first electrical signal SN1, or data read from the memory device 808 is transmitted as the second electrical signal SN2 to the second transmitter 809. The second electrical signal SN2 may include a clock signal and/or read data to be transmitted to the control unit 804.

The second transmitter 809 includes a second optical transmitter 809B. The second optical transmitter 809B converts the second electrical signal SN2 into a second optical transmission signal OPT2EC and transmits the second optical transmission signal OPT2EC to the optical link 801B. The second optical transmission signal OTP2EC is transmitted via the optical link 801B according to serial communication.

FIG. 17 illustrates an electro-photonic memory system 900 according to example embodiments of the inventive concepts.

Referring to FIG. 17, the electro-photonic memory system 900 includes a memory controller 902 and a plurality of memory modules 903. Each of the memory modules 903 may include a plurality of memory chips 904. The electro-photonic memory system 900 may have a structure in which second circuit boards 906 are inserted into sockets 905 of a first circuit board 901, respectively. The electro-photonic memory system 900 may be designed to have a channel structure in which one second circuit board 906 is connected to the first circuit board 901 for each signal channel. However, the inventive concepts are not limited thereto, and the electro-photonic memory system 900 may have any of other various structures.

In the memory modules 903, a signal may be transmitted using an electrical input/output (IO) connection.

The memory controller 902 is connected to a first conversion unit 907 via an electrical channel EC. The first conversion unit 907 converts an electrical signal received from the memory controller 902 via the electrical channel EC into an optical signal, and transmits the optical signal to an optical channel OC. Also, the first conversion unit 907 converts an optical signal received via the optical channel OC into an electrical signal, and transmits the electrical signal to the electrical channel EC.

Second conversion units 908 are connected to the first conversion unit 907 via the optical channel OC. An optical signal supplied to the memory modules 903 may be converted into electrical signals via the second conversion units 908, and the electrical signals may be transmitted to the memory chips 904. The electro-photonic memory system 900, including such optical connection memory modules, is capable of supporting a relatively high storage capacity and a relatively high operating speed.

The first conversion unit 907 may be packaged separately from the memory controller 902. The second conversion units 908 may be packaged as separate chips from the memory modules 903. Thus, the electro-photonic memory system 900 may be manufactured using the memory controller 902 or the semiconductor memory devices 904 that use only an electrical signal. Also, because information is exchanged between chips using an optical signal, limits to a signal processing speed and capacity, caused when data is transmitted using only an electrical signal, may be overcome.

While the inventive concepts has been particularly shown and described with reference to example embodiments thereof, it will be understood that various changes in form and details may be made therein without departing from the spirit and scope of the following claims.

What is claimed is:

1. An electro-photonic memory system comprising:
a semiconductor memory device for storing data by receiving a first electrical signal;
a memory controller for generating a second electrical signal to control the semiconductor memory device;
an electrical-to-optical converter for receiving the second electrical signal from the memory controller and converting the second electrical signal into an optical signal, the electrical-to-optical converter separate from the memory controller; and
an optical-to-electrical converter for receiving the optical signal from the electrical-to-optical converter and converting the optical signal into the first electrical signal.

2. The system of claim 1, wherein the optical-to-electrical converter is separate from the semiconductor memory device.

3. The system of claim 1, wherein the semiconductor memory device is a plurality of the semiconductor memory devices.

4. The system of claim 3, wherein
the optical-to electrical converter is a plurality of optical-to-electrical converters, and
the plurality of the semiconductor memory devices are connected to the plurality of optical-to-electrical converters, respectively.

5. The system of claim 4, further comprising:
an optical interconnector connected between the electrical-to-optical converter and each of the plurality of optical-to-electrical converters.

6. The system of claim 5, wherein the optical signal is a plurality of optical signals, further comprising:
an electrical-to-optical connector module including the electrical-to-optical converter and an optical splitter.

7. The system of claim 6, wherein the plurality of optical signals generated by the electrical-to-optical converter are supplied by the optical splitter to the plurality of optical-to-electrical converters, respectively.

8. The system of claim 1, wherein the optical-to-electrical converter is embedded in an optical cable.

9. The system of claim 1, wherein the electrical-to-optical converter is connected to the optical-to-electrical converter via an optical interconnector embedded in an optical cable.

10. The system of claim 1, wherein the electrical-to-optical converter is connected to the optical-to-electrical converter via an optical interconnector embedded in a mother board.

11. An electro-photonic memory system comprising:
a semiconductor memory device for storing data by receiving a first electrical signal;
a memory controller for generating a second electrical signal to control the semiconductor memory device;
an electrical-to-optical converter for receiving the second electrical signal from the memory controller and converting the second electrical signal into an optical signal; and
an optical-to-electrical converter for receiving the optical signal from the electrical-to-optical converter and converting the optical signal into the first electrical signal, the optical-to-electrical converter being separate from the semiconductor memory device.

12. The system of claim 11, wherein
the semiconductor device is a plurality of semiconductor memory devices,
the optical-to electrical converter is a plurality of optical-to-electrical converters, and
the plurality of semiconductor memory devices are connected to the plurality of optical-to-electrical converters, respectively.

13. The system of claim 11, wherein the optical-to-electrical converter is embedded in an optical cable.

14. The system of claim 11, wherein the electrical-to-optical converter is connected to the optical-to-electrical converter via an optical interconnector embedded in an optical cable.

15. The system of claim 11, wherein the electrical-to-optical converter is connected to the optical-to-electrical converter via an optical interconnector embedded in a mother board.

16. An electro-photonic memory system comprising an optical interconnector connected between an electrical-to-optical converter and at least one optical-to-electrical converter; and
a semiconductor memory device separate from the at least one optical-to-electrical converter.

17. The system of claim 16, wherein the at least one optical-to-electrical converter is embedded in an optical cable.

18. The system of claim 16, wherein the electrical-to-optical converter is connected to the at least one optical-to-electrical converter via the optical interconnector embedded in an optical cable.

19. The system of claim 16, wherein the electrical-to-optical converter is connected to the at least one optical-to-electrical converter via the optical interconnector embedded in a mother board.

20. The system of claim 16, further comprising:
a semiconductor memory device separate from the at least one optical-to-electrical converter.
